(19) United States
(12) Patent Application Publication
(10) Pub. No.: US 2018/0268496 A1
(43) Pub. Date: Sep. 20, 2018

(54) PHOTO BOOTH SYSTEM

(71) Applicant: Social Flash Media, Inc., Austin, TX (US)

(72) Inventors: Derick Alderman, Austin, TX (US); Stephen Scherer, Austin, TX (US); Gregory Bryant, Georgetown, TX (US); Phillip McCartney, Austin, TX (US)

(21) Appl. No.: 15/983,487

(22) Filed: May 18, 2018

Related U.S. Application Data
(63) Continuation of application No. 14/177,914, filed on Feb. 11, 2014.

(51) Int. Cl. G06Q 50/00; G03B 17/53; G06Q 30/02

(52) U.S. Cl. CPC G06Q 50/01; G03B 17/53; G06Q 30/0201

(57) ABSTRACT

A photo booth system including a photo booth, a management service, and a sharing system is described herein. The system is configured to capture photographs and promotional data from end users, edit the photographs, and to allow the end users to share the edited photographs on one or more sharing sites. The system is further configured to analyze the promotional data collected at the photo booth to generate one or more metrics for a merchant

### CROSS-REFERENCE TO RELATED APPLICATION(S)

This application is a continuation of and claims priority to U.S. application Ser. No. 14/177,914, filed on Feb. 11, 2014, and entitled “Photo Booth System,” the entirety of which is incorporated herein by reference.

### BACKGROUND

Many companies or individuals rent or purchase photo booths for use at special events and/or as a marketing tool. Typically, these photo booths are large self-contained units that are set up on-site by either an event coordinator or a booth administrator. Unfortunately, once set up and placed on-site the programs and/or applications originally selected by the event coordinator or booth administer may not be easily changed or updated without a second visit to the location of the photo booth.

Additionally, photo booths are fairly limited in terms of functionality and usability. Typical photo booths include options to take and print photos on site. However, the use of social media and other electronic avenues for sharing digital images has grown into an important part of today's culture. Typical photo booths lack any technique for the end users to receive digital or electronic images, which may be shared using social media or other electronic avenues.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example system including at least one photo booth in communication with at least one sharing system and a remote management service for sharing images according to some implementations.

FIG. 2 illustrates an example system including at least one photo booth in communication with a remote management service for automatically updating promotions according to some implementations.

FIG. 3 illustrates example components of a photo booth according to some implementations.

FIG. 4 illustrates example components of one or more servers associated with the management service according to some implementations.

FIG. 5 illustrates example components of sharing system according to some implementations.

FIG. 6 is an example flow diagram showing an illustrative process to update a photo booth according to some implementations.

FIG. 7 is an example flow diagram showing an illustrative process to generate promotional metrics for a merchant according to some implementations.

FIG. 8 is an example flow diagram showing an illustrative process for sharing photos according to some implementations.

### DETAILED DESCRIPTION

This disclosure includes techniques and implementations for providing a photo booth with image sharing capabilities and remote booth management. In particular, this disclosure describes a photo booth in communication with a management service. For instance, the photo booth may include one or more communication interfaces for communicating with one or more cloud-based management services over a network. The management service may update marketing campaigns and/or promotions associated with a merchant who has one or more ownership rights in the photo booth. The management service may also enable end users of the booth to share images or photos captured by the photo booth electronically via one or more sharing sites, such as one or more social media websites (e.g., Facebook®, Twitter®, Flickr®, Instagram®, among others).

The techniques described herein achieve photo sharing via sharing sites by including a sharing system, which may be incorporated into the photo booth (e.g., physically incorporated into the back of the booth), a separate self contained system in communication with the cloud-based management service or the photo booth itself. In some cases, the sharing system may not be remote from the photo booth. For example, an end user of the photo booth may enter the booth and take one or more photographs. The photographs may then be stored locally at the photo booth and/or provided to the management service via one or more networks. The photographs (i.e., the images captured by the photo booth) may then be provided to the sharing systems either by the management service or the photo booth.

The user may then view the photographs at the sharing system. At the sharing system, the user may select one or more photographs for uploading to one or more sharing sites. For instance, the user may have an account with Facebook® and the user may select one or more of the photographs (images) at the sharing system for posting on Facebook®. The sharing system may request that the user authorize the management service to access and post the selected photographs on the user account from Instagram®. If the user provides the authorization information at the sharing system, the sharing system may obtain the authorization (e.g., an authorization token) from the sharing site using the authorization information. The sharing system may then provide the authorization information and at least an identification of the selected photographs to the management service. The management service may be configured to access the user's account at the sharing site (e.g., Facebook®) using the authorization information and post the selected photographs.

In another implementation, all client systems, booths and sharing systems, are enabled and controlled through the marketing campaigns and promotions created by specific merchants (for example, either manually via a merchant interface at the cloud-based management service or automatically based on a time of day, expiration of predetermined duration, or collection of a predetermined number of photos or images). Promotions are configured by the merchant to collect marketing data related to one or more products or industries. The promotional assets may include one or more image assets to be applied to any photograph or image captured by the photo booth (e.g., backgrounds or borders containing a trademark or logo of the merchant or product), one or more survey questions and/or answers that may be collected as marketing data by the photo booth from an end user in exchange for the photograph, additional marketing messaging to be included with any photos shared via a sharing site, the set of sites to be used for sharing, and/or one or more advertisements that may be displayed by the photo booth. In some implementations, the merchant may update the campaigns and/or promotions by logging on to a merchant interface at a cloud-based management service. Using the merchant interface, the merchant may be able to access the photo booths, upload promotional assets, update current promotions or campaigns (e.g., switch a current promotion or set one or more thresholds for automatically switching the current promotion), assign photo booths to particular campaigns or promotions, assign one or more sharing systems to particular campaigns or promotions, select one or more sharing sites to make available to end users at the sharing system, etc.

In some examples, the merchant may configure the management service to provide photographs and images at regular intervals for updating the merchant websites. For instance, when compiling search results, many search engines rank regularly updated websites or websites with new content higher on the result list. By configuring the management services to provide regularly scheduled updates (e.g., image content captured by the photo booth) to the merchant's website, the merchant may be able to improve the merchant's website ranking in search results returned by the various search engines.

In some particular implementations, the photo booths may be configured to collect promotional data related to one or more promotions from the end users of the photo booth. For example, the merchant may identify or provide one or more survey questions presented to the end users of each photo booth participating in a particular promotion for the duration of the particular promotion. The photo booths may be configured to collect the answers to the survey questions and to provide the answers to the management service as promotional data. In some examples, the photo booth may store the answers locally and provide the answers to the management service when the promotion ends or at a later time (e.g., the next time the photo booth is connected to a network). In other examples, the photo booth may provide the answers to the management service via the network as the answers collected.

In some implementations, the management service also includes a data analysis module for generating metrics associated with each promotion and/or campaign for the merchant For instance, the management service may receive promotional data (e.g., survey question answers, time of day collected, and/or some amount of user information) and correlate the answers based on the particular photo booths (or photo booth locations) that collected the data. As illustrative examples, the management service may generate metrics such as users of photo booth A located at the movie theater most commonly selected answer D, while users of photo booth B located at the grocery store most commonly selected answer C, users most commonly selected answer A in the morning and answer B in the evening, and/or users who indicated they were under 20 most commonly selected answer B, while users who indicated they were over 20 most commonly selected answer A. Once generated, the metrics are made available to the merchant via a merchant interface or sent to the merchant (e.g., via email).

In one particular example, the merchant may upload promotional assets (e.g., a photo border with the merchant's logo, a survey question and/or an advertisement) associated with two promotions of a marketing campaign related to a new product to the management service. For instance, the merchant may select a first survey question, such as at what purchase price the end user would purchase the new product, and include four ranges as selectable answers, as part of the first promotion, and a second survey question, such as what colors the end user would prefer that the new product be released in, and a user selectable color pallet, as part of the second promotion. The merchant may also select one or more photo booths to which to apply the promotions and a duration for each of the promotions.

The management service provides the promotional assets related to both promotions to the selected photo booths. In some cases, once the assets associated with the first promotion are received, the photo booth begins to ask each user attempting to take a photograph the survey question associated with the first promotion and to monitor the amount of time that the first promotion is active. Each time the photo booth captures an image or photo of an end user, the photo booth prompts the user to answer the first survey question before allowing the user to take the photo. During the time period that the first promotion is active, the photo booth continues to collect photos, as well as promotional data (e.g., the answers to the first survey question). The photo booth may provide the photos and the promotional data to the management service, and the management service may provide the photos to the sharing system. Alternatively, the photo booth may provide the photos and the promotional data directly to the sharing system.

Once the photos are received, the sharing system may display the photos and allow the user to select one or more of the images and one or more sharing sites. The sharing system may allow the end user to provide authentication information (either at the sharing system or directly to the sharing sites) to allow the sharing system to obtain an authorization for the management services to access and post the one or more photos selected by the user to the user's account at the sharing sites. For example, the sharing system may obtain an authorization token from the sharing site by allowing the user to access the sharing site and enter the authorization information directly at the sharing site. In response, the sharing site provides an authorization token to the sharing system. The sharing system may then provide the authorization token and an indication of the selected photo the management service, which posts the photos to the user's account at the sharing site. In this mariner, the user is able to share any photos or images captured by the photo booth using their accounts at sharing sites.

The management service also analyzes the promotional data provided by the photo booth. For instance, the management service may generate one or more metrics related to the survey questions based on information collected from or known about the end users and/or information known about the location of the photo booth. For example, the management service may mine the public information related to the user and/or posted by the user on the user's account at the sharing site identified by the user at the sharing system. The management service may also edit each photo based on the promotional assets associated with the current promotion before providing the photo to the sharing system for display. For example, the management service may apply a logo associated with the merchant around the border of each photo. Once edited, the photos are provided to the sharing system for viewing by the user.

In some examples, the photo booth advances to the second promotion upon the expiration of a duration assigned to the first promotion by the merchant In other instances, the management service may track the interval that the first promotion is active on the photo booth and provide an update signal or the promotional assets related to the second promotion when the interval exceeds the duration assigned by the merchant In some instances, the merchant may also manually switch the photo booth to the second promotion before the duration associated with the first promotion expires. In other examples, the merchant may set other switching criteria, such as a time of day, a threshold number of photos or images captured by the photo booth, and/or a threshold number of photos or images captured of a single user or group of users.

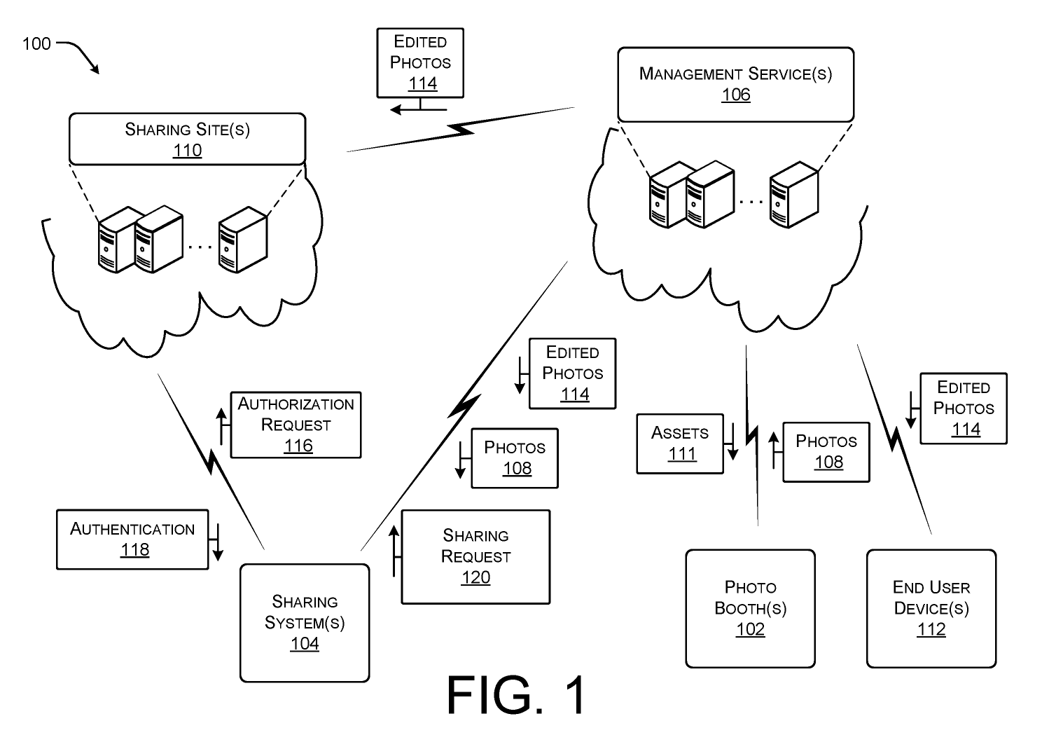

FIG. 1 illustrates an example system 100 including at least one photo booth 102 in communication with at least one sharing system 104 and at least one remote management service 106 for sharing photos 108 according to some implementations. The management service 106 is also in communication with one or more sharing sites 110 and/or one or more end user devices 112 to facilitate sharing electronic or digital versions of the edited photos 114 (or images) captured by the photo booth 102. For example, an end user may enter the photo booth 102, the photo booth 102 may capture one or more photos 108 of the end user, the end user may select one or more of the edited photos 114 for sharing on one or more of the sharing sites 110 and/or the end user devices 112 using the sharing system 104.

The photo booth 102 is a self contained unit for taking photos 108. The photo booth 102, generally, includes at least one camera for capturing visual data (photos or images) from the environment and a communication interface for providing the photos 108 and/or edited photos 114 (or images) to the management service 106. In some cases, the photo booth 102 may be installed in a permanent location, while in other cases, the photo booth 102 may be portable. For example, the photo booth 102 may be collapsible or modular, such that the photo booth 102 may be disassembled, moved to a new location, and reassembled. In some instances, the photo booth 102 may be configured to provide an enclosed environment from which the photos 108 of end users may be captured, while in other instances, the photo booth 102 may be an open air design (e.g., no doors, back wall, or curtains). In one particular implementation, the photo booth 102 may be convertible from an open air system to an enclosed system.

The sharing system 104 may be one or more computing devices (e.g., a notebook computer, desktop computer, tablet computer, smart phone, specialized computing device, etc.) configured to present the photos 108 to the end user. The sharing system 104 may also be configured to allow the end user to select one or more of the photos 108 for sharing on one or more sharing sites 110 and/or to one or more end user devices 112. In some examples, the sharing system 104 may be configured to obtain authorization (or an authorization token) from the end user for the one or more sharing sites 110 to allow the management service 106 to post the photos 108 (or images) on the one or more sharing sites 110.

In some particular implementations, the sharing system 104 may be incorporated into the housing (for example, the back, side, or other portion of the housing) of the photo booth 102, such that the end user may enter the photo booth 102, the photo booth 102 may capture one or more photos 108 of the end user, the end user may exit the photo booth 102, and the end user may share the photos 108 using the integrated sharing system 104, while the photo booth 102 may be capturing photos 108 of another end user. In other implementations, the sharing system 104 is a standalone system that may be in wired or wireless communication with the photo booth 102 and/or the management service 106.

Both the photo booth 102 and the sharing system 104 are in communication with the cloud-based management service 106. For instance, the photo booth 102 and sharing system 104 may be configured to communicate with the management service 106 over one or more networks (not shown) via wired technologies (e.g., wires, USB, fiber optic cable, etc.), wireless technologies (e.g., RF, cellular, satellite, Bluetooth, etc.), or other connection technologies. The networks may be any type of communication network, including data and/or voice network, and may be implemented using wired infrastructure (e.g., cable, CAT5, fiber optic cable, etc.), a wireless infrastructure (e.g., RF, cellular, microwave, satellite, Bluetooth, etc.), and/or other connection technologies. In general, the networks carry data, such as the photos 108, between the photo booth 102, the sharing system 104, and the management service 106.

The management service 106 may host any number of cloud-based services for sharing photos 108 captured by each photo booth 102 and/or for managing the operations of each photo booth 102. The management service 106, as illustrated, is implemented as one or more cloud-based services hosted on servers. In general, cloud-based services refer to a network accessible platform implemented as a computing infrastructure of processors, storage, software, data access, and so forth that is maintained and accessible via a network such as the Internet. The cloud-based services do not require end-user knowledge of the physical location and configuration of the system that delivers the services. Common expressions associated with cloud services include “on-demand computing,” “software as a service (SaaS),” “platform computing,” “network accessible platform” and so forth.

The servers may include various types of computing devices and may be owned by a single entity and collocated at a common data center or may be located at separate data centers. Alternatively, the servers may be owned and operated by independent entities at separate locations. The servers may be further arranged in any number of ways, such as server farms, stacks, and the like that are commonly used in data centers.

The management service 106 may include one or more services for editing or modulating the photos 108 to generate edited photos 114. For instance, the management service 106 may be configured to edit or modulate the photos 108 based on instructions provided by a merchant having an ownership interest in the photo booth 102. For example, the management service 106 may store one or more promotional assets received from the merchant as part of a promotion (such as a border with the merchant's logo), which the management service 106 may apply to each of the photos 108 upon receipt.

In other examples, the management service 106 may apply one or more backgrounds to the photos 108 and/or add objects (product placements) to the photos 108, such as placing a product that may be purchased from the merchant in the hands of the end user or adding a graphic to clothing worn by the end user. In one particular example, the management service 106 may stretch, blur, grayscale, or perform other image editing techniques to the photos 108. In some implementations, the management service 106 may generate multiple edited or modulated photos 114 from each of the photos 108 captured by the photo booth 102 and provide each of the edited or modulated photos 114 to the sharing system 104. In some instances, the management service 106 may provide both the photos 108 and the edited photos 114 to the sharing system 104.

The sharing sites 110 may include one or more social media websites or one or more photo sharing sites, for example, Facebook®, Twitter®, Flickr®, Instagram®, etc. Typically, the end user has an account with the particular sharing site 110 and is able to authorize the management service 106 to post or add photos 108 captured by the photo booth 102 to the end user's account. For example, the end user may authorize the management service 106 to post photos 108 to the end user's wall on the end user's Facebook® account.

The end user devices 112 include one or more computing devices (e.g., a notebook computer, desktop computer, tablet computer, smart phone, etc.) that the end user desires to receive the edited photos 114. In some instances, the end user devices 112 may be one or more storage devices associated with the user, for example, the end user may have a subscription based or cloud-based storage service, to which the photo may be delivered.

In an example, the end user may enter a photo booth 102 of the system 100. The photo booth 102 may capture one or more photos 108 (or images) of the end user, while the end user is using the photo booth 102. The photo booth 102 may store the photos 108 locally and provide the photos 108 to the management service 106. In some cases, the photo booth 102 collects the photos 108 on an internal storage media and provides the collection of photos to the management service 106 when connected to one or more networks. In other cases, the photo booth 102 may store the photos 108 locally as a back up and provide the photos 108 to the management service 106, as each photo 108 is captured (e.g., in substantially real-time). In some particular implementations, the photo booth 102 may also provide the photos 108 or the edited photos 114 directly to the sharing system 104. For example, if the sharing system 104 is incorporated into the photo booth 102, the sharing system 104 may be configured to access the photos 108 maintained in the local storage media of the photo booth 102, or the photo booth 102 may provide the photos 108 to the sharing system 104 over a short range wireless protocol.

After the photos 108 are captured and provided to the management service 106, the management service 106 may edit or modulate the photos 108 to generate the edited photos 114. The management service 106 may provide the edited photos 114 to the sharing system 104. For example, the management service 106 may have applied a merchant's logo to each of the photos 108 captured by a particular photo booth 102, such that the photo booth 102 generates an edited photo 114.

Once the edited photos 114 are generated (e.g., the merchant's logo applied), the management service 106 provides the edited photos 114 to the sharing system 104. At the sharing system 104, the end user may view the edited photos 114 and select individual ones of the edited photos 114 to be shared on one or more sharing sites 110, provided to one or more end user devices 112, or both. For example, the end user may select one or more of the edited photos 114 to be emailed to an email account associated with the end user and posted on the user's account at Facebook®.

In another example, the end user may select a sharing site 110 (e.g., Facebook®) for sharing one or more of the edited photos 114. In this example, the sharing system 104 provides an authentication request 116 to the sharing site 110 to receive permission for the management service 106 to access the user's account at the sharing site 110. For example, the sharing system 104 may provide an interface to obtain the authentication 118 by allowing the end user to enter their login credentials directly to the sharing site 110. In some instances, the authentication 118 may be an authentication token or onetime use token that allows the management service 106 to post the edited photos 114 without having full access or continual access to the end user's account at the sharing site 110. In addition, by utilizing the authentication tokens the end user does not have to provide any login credentials to the management service 106.

Once the authentication 118 is obtained, the sharing system 104 provides a sharing request 120 including an indication of the selected photos and the authentication 118 to the management service 106. The management service 106 may then provide the selected and/or edited photos 114 to the selected sharing site 110 with the authentication 118 to cause the sharing site 110 to post the edited photos 114 on the user's account.

As illustrated, the system 100 includes a photo booth 102 configured to communicate with the management service 106 and the sharing system 104 to enable an end user to share photos 108 captured by the photo booth 102 on one or more sharing sites 110. Additionally, the system 100 allows a merchant to cause the photos 108 captured by the photo booth 102 to be edited or modulated in a manner desired by the merchant before the photos 108 are presented to the end user at the sharing system 104 or posted on one or more of the sharing sites 110, for example, image recognition may be used to identify if the photos 108 are of a man or a women and the photos 108 of a man may have a first logo associated with a first product owned by the merchant applied (e.g., a fishing gear logo), while photos 108 of a women may have a second logo associated with a second product owned by the merchant applied (e.g., a clothing brand logo).

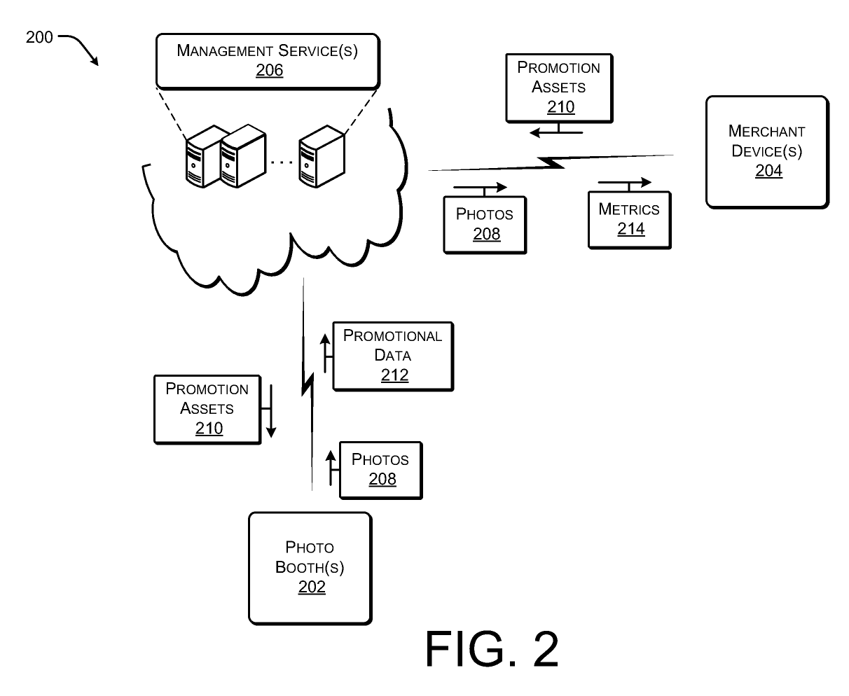

FIG. 2 illustrates an example system 200 including a photo booth 202 and a remote management service 206 for automatically updating promotions according to some implementations. In general, the management services 206 are in communication with both the photo booth 202 and a merchant device 204, such that a merchant may input or select one or more promotions to be run on the photo booth 202 by uploading or selecting one or more promotional assets 210 associated with each promotion.

As discussed above, the photo booth 202 is a self contained unit for taking photos 208. The photo booth 202, generally, includes at least one camera for capturing visual data from the environment and a communication interface for providing the photos 208 to the management service 206. In addition to the camera and communication interface, the photo booth 202 includes a user interface for collecting promotional data 212 from the user in exchange for the photo 208.

The promotional data 212 may include survey questions and user answers collected by the photo booth 202, statistics related to a time of day the photo booth 202 captured photos 208, and/or some amount of user information (e.g., information obtained about the user from the user's account at one or more sharing sites). For example, the photo booth 202 may be configured to ask the end user to answer one or more promotional questions before capturing any photos or images.

The management service 206 is configured to receive the promotional assets 210 associated with one or more promotions from the merchant device 204. The promotional assets 210 may include one or more image assets to be applied to any photograph taken using the photo booth 202 (e.g., backgrounds or borders containing a trademark or logo of the merchant), one or more end user questions and/or answers that may be collected as promotional data 212 by the photo booth 202 from an end user in exchange for the photo 208, and/or one or more advertisements that may be displayed by the photo booth 202 or the sharing system in conjunction with the photos 208.

The management service 206 may also receive the promotional data 212 from the photo booth 202, in addition to the photos 208 as described above with respect to FIG. 1. The management service 206 may be configured to analyze the promotional data 212 and to generate promotional metrics 214. For example, the management service 206 may correlate user information obtained from a user account at a sharing site with the user's answers to the survey questions (e.g., 95% of users between the ages of 20 and 30 selected answer A). In some implementations, the management service 206 may generate the metrics 214 in response to a particular promotion or campaign coming to an end, while in other implementations the management service 206 may generate the metrics 214 on an ongoing basis as each end user utilizes the photo booth 202. The management service 206 may also make the metrics 214 available or provide the metrics 214 to the merchant devices 204.

In an example, the promotional assets 210 are received by the management service 206 from the merchant devices 204. The management services 206 may apply some of the assets, while the management services 206 may cause the photo booth 202 to apply other assets. For instance, the management services 206 may provide the promotional assets 210 including the one or more end user questions and/or corresponding answer options to the photo booth 202, while the management services 206 applies other promotional assets 210, such as one or more image assets, to the photos 208 captured by the photo booth 202, before providing to a sharing system or posting on a sharing site.

In one particular implementation, the promotional assets 210 may include a duration associated with each promotion. The duration may be an amount of time, a number of photos, or even a time of day during which a particular promotion should run. For example, the management services 206 may receive promotional assets related to a campaign having a first promotion and a second promotion. The promotional assets 210 associated with the first promotion may include a first duration (e.g., 20 hours), and the second promotion may include a second duration (e.g., 15 hours). In some cases, the merchant device 204 may also provide the management services 206 with an indication that the first promotion should be applied by the photo booth 202 before the second promotion (i.e., an indication of the order in which the promotions should be applied).

In general, the management services 206 provide at least some of the promotional assets 210 related to the first and second promotion to the photo booth 202. In some implementations, the management services 206 may monitor the interval that the first promotion is applied by the photo booth 202 and instruct the photo booth 202 to apply the second promotion after the expiration of the first duration (e.g., after the first promotion is applied for 20 hours). In other implementations, the photo booth 202 may monitor the interval that the first promotion is applied and switch to the second promotion automatically when the interval exceeds the first duration.

In some particular implementations, the merchant may include promotional assets 210 associated with the time of day that a promotion may be applied. For instance, the photo booth 202 may apply the first promotion of a campaign during the morning hours and the second promotion during the evening hours. For example, the photo booth 202 may be located at a restaurant and the first promotion may be related to the breakfast menu and the second promotion may be related to the dinner menu. By switching the promotions based on the time of day, the photo booth 202 may collect targeted promotional data 212 related to the meal that the end user consumes.

In one particular implementation, the photo booth 202 may switch promotions based on a combination of criteria. For example, the photo booth 202 may be located in the lobby of a movie theater and the movie theater may be open during the hours of 8:00 am to 10:00 pm or for 14 hours a day. In the present example, the first promotion has a duration of 20 hours, which is greater than the 14 hours that the movie theater is open. In this instance, the promotional assets 210 may include parameters, which cause the photo booth 202 to apply the promotions during the hours of 8:00 am to 10:00 pm but not during the hours of 10:00 pm to 8:00 am, as no end users will be able to access the photo booth 202 while the movie theater is closed. In this way, if the first promotion begins at 8:00 am on day one, the photo booth 202 runs the first promotion for 14 hours on day one (i.e., from 8:00 am to 10:00 pm) and 6 hours on day two (i.e., from 8:00 am to 2:00 pm). At 2:00 pm on day two, the photo booth 202 switches from the first promotion to the second promotion and runs the second promotion for 8 hours on day two (i.e., from 2:00 pm to 10:00 pm) and for the remaining 2 hours on day three (i.e., from 8:00 am to 10:00 am).

In general, following the expiration of the last promotion, the photo booth 202 may be configured to apply a default promotion (e.g., a promotion to run when no other promotion is selected by the merchant) or, in other cases, the photo booth 202 may return to the first promotion of the campaign and continue to cycle between the promotions until the merchant provides additional promotional assets 210 associated with a new or updated campaign to the management service 206.

In some implementations, the merchant is able to replace or update the promotions at any time. For instance, in the movie theater example above, if the first promotion has run for 15 hours, the merchant may access the management services 206 via the merchant devices 204 and upload promotional assets 210 associated with a third promotion. In some cases, when the merchant uploads the third promotion, the merchant may cause the third promotion to take effect immediately. In this example, the management services 206 may provide at least some of the promotional assets 210 associated with the third promotion to the photo booth 202. The management services 206 also cause the photo booth 202 to apply the third promotion even though the first duration has not elapsed.

During each of the promotions, the photo booth 202 collects promotional data 212 from each of the end users who utilize the booth 202. For instance, each promotion may include one more survey questions and corresponding answers. The photo booth 202 may request that the end user answer at least one of the survey questions before a photograph 208 is captured. In some cases, if the promotion includes more than one survey question, the photo booth 202 may be configured to ask the questions in a predetermined or a random order. The photo booth 202 may also be configured to ask each question a threshold number of times. For example, the photo booth 202 may ask a first question to the first two hundred end users who utilize the photo booth 202 during the promotion and ask a second question to the next four hundred end users who utilize the photo booth 202 during the same promotion.

The photo booth 202 provides the photos 208 and the promotional data 212 collected from the end users to the management services 206. The management service 206 analyzes the promotional data 212 to generate promotional metrics 214. In some cases, the management services 206 may also correlate the promotional data 212 received from the photo booth 202 with additional data mined or collected from sharing sites selected by one or more of the end users for sharing one or more of the photos 208. For example, if the end user requests a photo 208 to be shared on the end user's Facebook® account, the management services 206 may collect public data about the end user from the end user's Facebook® page. Once generated, the management services 206 provides the metrics 214 to one or more merchant devices 204 or makes the metrics 214 available to the merchant (e.g., via a web interface at the management services 206), such that the merchant is able to access and review the metrics 214.

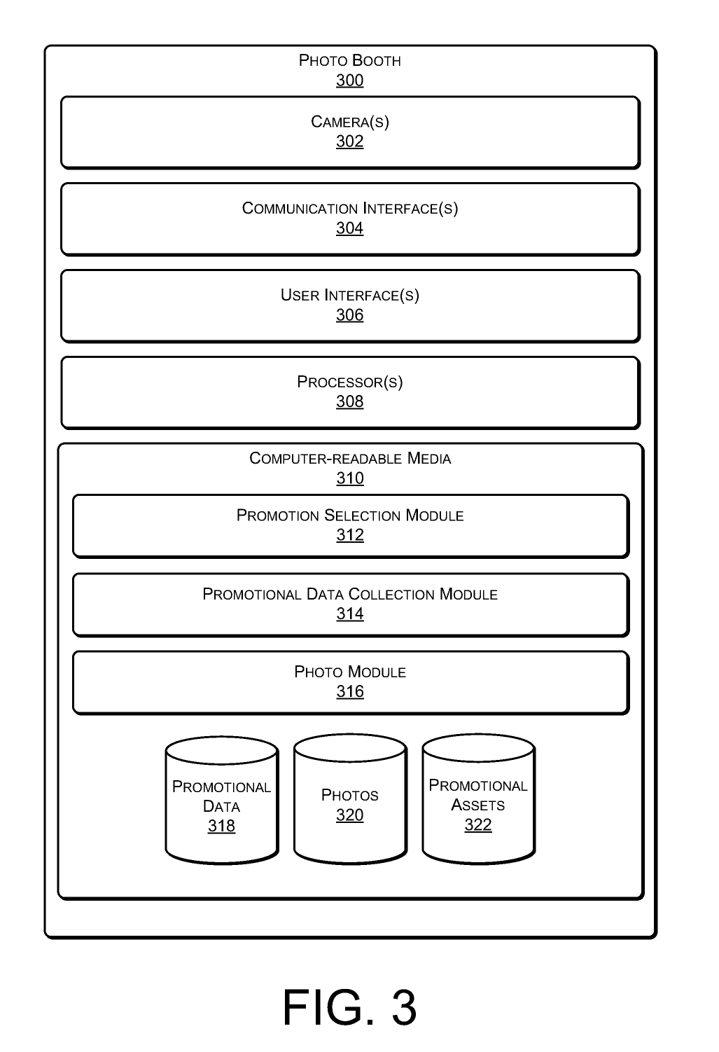

FIG. 3 illustrates an example architecture of a photo booth 300 according to some implementations. Generally, the photo booth 300 is a self contained unit for taking photos. The photo booth 300 includes at least one camera 302 for capturing visual data from the environment, at least one communication interface 304 for providing the photos to a management service associated with the photo booth 300, and at least one user interface 306 for collecting promotional data from the end user. In some cases, the photo booth 300 may be installed in a permanent location, while in other cases, the photo booth 300 may be portable. For example, the photo booth 300 may be collapsible or modular, such that the photo booth 300 may be disassembled, moved to a different location, and then reassembled. In some instances, the photo booth 300 may be configured to provide an enclosed environment from which the photos 300 of end users may be captured, while in other instances, the photo booth 300 may be an open air design. In one particular implementation, the photo booth 300 may be convertible from an open air system to an enclosed system.

The one or more cameras 302 may be placed throughout the photo booth 300. For example, the cameras 302 may be positioned to take multiple photographs of an end user within the photo booth 300 at various angles and/or views. The cameras 302 may be of various sizes and quality, for instance, the cameras 302 may include one or more wide screen cameras, high definition cameras, video cameras, among other types of cameras.

The one or more communication interfaces 304 are configured to facilitate communication between one or more networks and/or one or more cloud-based management services (e.g., management services 106 and 206) and the photo booth 300. The communication interfaces 304 may also facilitate communication between one or more wireless access points, a master device, and/or one or more other computing devices as part of an ad-hoc or home network system. The communication interfaces 304 may support both wired and wireless connection to various networks, such as cellular networks, radio, WiFi networks, short-range or near-field networks (e.g., Bluetooth®), infrared signals, local area networks, wide area networks, the Internet, and so forth. In some cases, the communication interfaces 304 may also enable device to device communication such as between photo booth 300 and one or more printers and/or one or more other electronic devices in proximity to the photo booth 300.

The user interfaces 306 may include both output interfaces for displaying or providing information to an end user and input interfaces for receiving user inputs from the end user. The user interfaces 306 may include various systems for interacting with the photo booth 300, such as mechanical input devices (e.g., keyboards, mice, buttons, etc.), displays, touch screens, input sensors (e.g., motion, fingerprint, facial recognition, or gesture sensors), and/or microphones and speakers for capturing natural language input such as speech.

The photo booth 300 includes one or more processors 308, such as at least one or more access components, control logic circuits, central processing units, or processors, as well as one or more computer-readable media 310 to perform the function of the photo booth 300 and/or store content. Additionally, each of the processors 308 may itself comprise one or more processors or processing cores.

Depending on the configuration, the computer-readable media 310 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 308.

Several modules such as instruction, data stores, and so forth may be stored within the computer-readable media 310 and configured to execute on the processors 308. For example, as illustrated, the computer-readable media 310 stores a promotion selection module 312, a promotional data collection module 314, and a photo module 316. The promotion selection module 312 may be configured to select between multiple available promotions. For example, as described above, the promotional selection module 312 may cycle through the available promotions based on a duration configured by the merchant and associated with each promotion. The promotional data collection module 314 may be configured to prompt the end user to answer survey questions associated with the selected promotion and to store the answers. The photo module 316 may be configured to capture an image or photograph of the end user after the end user answers the survey questions presented by the promotional data collection module 314. In one particular implementation, multiple photo booths 300 may be utilized in combination such that the promotion selection module 312 of each photo booth 300 is configured to select an identical promotion and the photo module 316 of each photo booth 300 may be configured to capture one or more photos 330 of a user in combination. For example, a user may answer a survey question at the first photo booth and proceed to walk or run through a course having multiple other photo booths each of which captures a photo 330 of the user in response to the user answering the survey question at the first photo booth.

The computer-readable media 310 may also be configured to store data, such as promotional data 318, photos 320, and/or promotional assets 322. The promotional data 318 is data collected by the photo booth 300 associated with the selected promotion. The promotional data 318 may be used by the management services to generate one or more metrics, which may be provided to the merchant for use in the merchant's business development. The photos 320 are the one or more photos or images captured by the photo booth 300 of one or more end users and the promotional assets 322 include various assets associated with a promotion, such as a duration of each promotion, other stopping criteria, and/or survey questions and answers. The promotional data 318 and the photos 320 may be stored locally on the computer-readable media 310 as a back-up until the data 318 and the photos 320 can be provided to the management services and/or until the communication interfaces can establish a communication channel with the management services, such as when the photo booth 300 is located in a remote area (e.g., an outdoor concert or county fair).

In general, the photo booth 300 receives promotional assets 322 from the management services (such as management services 106 or 206 of FIGS. 1 and 2) over at least one of the communication interfaces 304. The photo booth 300 stores the promotional assets 322 locally in the computer-readable media 310. The processors 308 execute the promotion selection module 312, which selects promotions associated with the promotional assets 322 to be applied by the photo booth 300. For example, the promotion selection module 312 may select promotional assets related to a first promotion of a campaign to be applied by the photo booth 300. The promotion selection module 312 may then cause a second promotion of the campaign to activate in response to an interval of time associated with the first promotion exceeding the duration.

Once a promotion is selected, whenever an end user uses the photo booth 300, the processors 308 execute the promotional data collection module 314, which requests that the end user answer one or more survey questions stored locally as promotional assets 322 in the computer-readable media 310. The promotional data collection module 314 may then cause the answers (and in some cases data related to the user) to be stored locally as promotional data 318. The promotional data collection module 314 may also send the promotional data 318 collected from the end users to the management services for analysis via one or more of the communication interfaces 304.

After the promotional data 318 is collected by the promotional data collection module 314, the processors 308 execute the photo module 316, which causes the cameras 302 to capture one or more photographs 320 of the end user. In some implementations, the photos 320 may be modulated to produce edited versions using the promotional assets 322. The photos 320 are provided to the management services, together with the promotional data 318 for sharing on one or more sharing sites. In some alternative implementations, the promotional data 318 may be collected by the promotional data collection module 314 after the photo module 316 cause the cameras 302 to capture the one or more photographs 320. In one particular implementation, the promotional data collection module 314 may be incorporated into the sharing system and the promotional data 318 is collected before the photographs 320 are presented to a user.

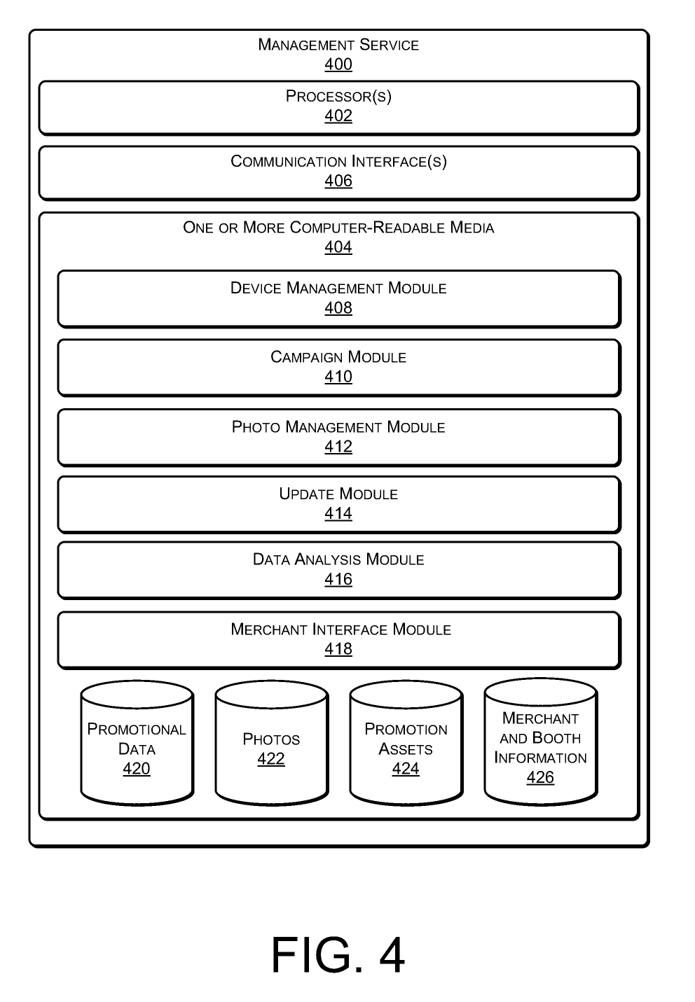

FIG. 3 provides example architecture of a photo booth. FIG. 4 provides an example architecture of the management services that operate in conjunction with the photo booth to facilitate the systems of FIGS. 1 and 2.

FIG. 4 illustrates an example architecture of one or more servers associated with the management service 400 according to some implementations. The servers, which host the management service 400 collectively comprise processing resources, as represented by processors 402, and computer-readable storage media 404. The computer-readable storage media 404 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

The servers may also include one or more communication interfaces 406, which may support both wired and wireless connection to various networks, such as cellular networks, radio (e.g., radio-frequency identification RFID), WiFi networks, short-range or near-field networks (e.g., Bluetooth®), infrared signals, local area networks, wide area networks, the Internet, and so forth. For example, the communication interfaces 406 may allow the management services 400 to receive photos and promotional data from one or more photo booths, such as photo booths 102, 202, and/or 300, as well as to communicate with one or more sharing systems and/or merchant devices operating either in the cloud or co-located with the photo booths. In the latter case, the co-located management service may act as a proxy or additional tier for a cloud-based management service.

Several modules such as instruction, data stores, and so forth may be stored within the computer-readable media 404 and configured to execute on the processors 402. For example, a device management module 408 may be provided to manage one or more photo booths associated with a merchant and a campaign module 410 may be provided to manage various marketing campaigns associated with the one or more photo booths associated with the merchant The computer-readable media 404 may also include a photo management module 412 to edit or modulate the photos received by the photo booths based on one or more image assets or promotional assets associated with a promotion running on a particular photo booth and an update module 414 to update a promotion running on the particular photo booth. The computer-readable media 404 may also include a data analysis module 416 to generate metrics associated with a promotion based on promotional data received from one or more photo booths and a merchant interface module 418 to allow the merchant or a merchant device to access the generated metrics.

In some specific implementations, the computer-readable media 404 may store the promotional data 420 and photos 422 received from the photo booths, as well as promotional assets 424 received from the merchant. In some implementations, the computer-readable media 404 may also store merchant and booth information 426 that may include an identity of the merchant, campaign or promotion histories, indicating which photo booths are associated with each merchant, the location of each booth (e.g., business or event information), information related to the venue of each booth (e.g., hours of operation for the venue), analytics and statistics related to the operation of each booth (e.g., number of photos per hour, number of repeat users, etc.), volume associated with each booth (e.g., number of photos, number of different users, etc.) and/or other information.

Generally, the management services 400 receive promotional assets 424 associated with one or more promotions of a campaign implemented by a merchant accessing the management services 400 via the merchant interface module 418. The processors 402 execute the device management module 408 and the campaign module 410 to determine which photo booths assigned to the merchant are associated with the campaign and should receive the promotional assets 424. Once the photo booths are identified, the update module 414 provides the promotional assets 424 related to the new promotions to the selected photo booths, which causes the photo booths to begin to apply the promotion related to the promotional assets received from the merchant In some particular implementations, the update module 414 may monitor the duration or other stopping criteria that a promotion is active on each photo booth and provide an update signal that causes the photo booth to apply a second promotion associated with a campaign when the duration exceeds a threshold set by the merchant In other implementations, the update module 414 may provide an update signal to a photo booth in response to an input by the merchant at the merchant interface.

The management services 400 also receive photos 422 and promotional data 420 associated with one or more promotions from the photo booths. In response to receiving the photos 422, the processors 402 execute the photo management module 412 that is configured to apply one or more of the promotional assets 424 to each of the photos 422. For example, the photo management module 412 may apply image assets (e.g., a border, merchant's logo, or image processing effect), audio assets (audio tracks, music, voiceovers, etc.), and/or video assets (animation, fads, etc.) to each image according to the assets provided by the merchant with respect to each promotion. The photo management module 412 may also be configured to communicate with one or more sharing systems. For instance, the photo management module 412 may provide the edited photos to a sharing system assigned to the photo booth, which provided the photo 422, as illustrated in FIG. 1. In some instances, the management services 400 may receive a sharing request and/or an authorization from a sharing system to share a particular photo on a sharing site, email or text the photo, or to provide the photo directly to a local device (such as a printer). In this instance, the photo management module 412 may be configured to access the sharing site using the authorization and to post the particular photo on the site.

In response to receiving the promotional data 420, the processors 402 execute the data analysis module 416 that is configured to generate one or more metrics based on the promotional data 420 and the merchant and booth information 426. The data analysis module 416 may also be configured to obtain and correlate the promotional data 420 with user information known or discovered about one or more users of the particular photo booth. For example, if an end user provides a sharing request and authorization to share one or more photos 422 on a sharing site, the data analysis module 416 may be configured to mine public information posted on the end user's account or page at the sharing site. The data analysis module 416 may then correlate the user information mined from the accounts of multiple users with the promotional data 420 collected from those same users or other end users.

The management services 400 may make metrics, analysis, or data generated by the data analysis module 416 available to the merchant via the merchant interface module 418. For example, the merchant may be able to log into the management services 400 and view the metrics. In some implementations, the merchant interface module 418 may also cause photos 422 received from the photo booths to be uploaded to the merchant's website to continually provide refreshed content on the merchant's website and potentially improve the search result ranking of the merchant's website.

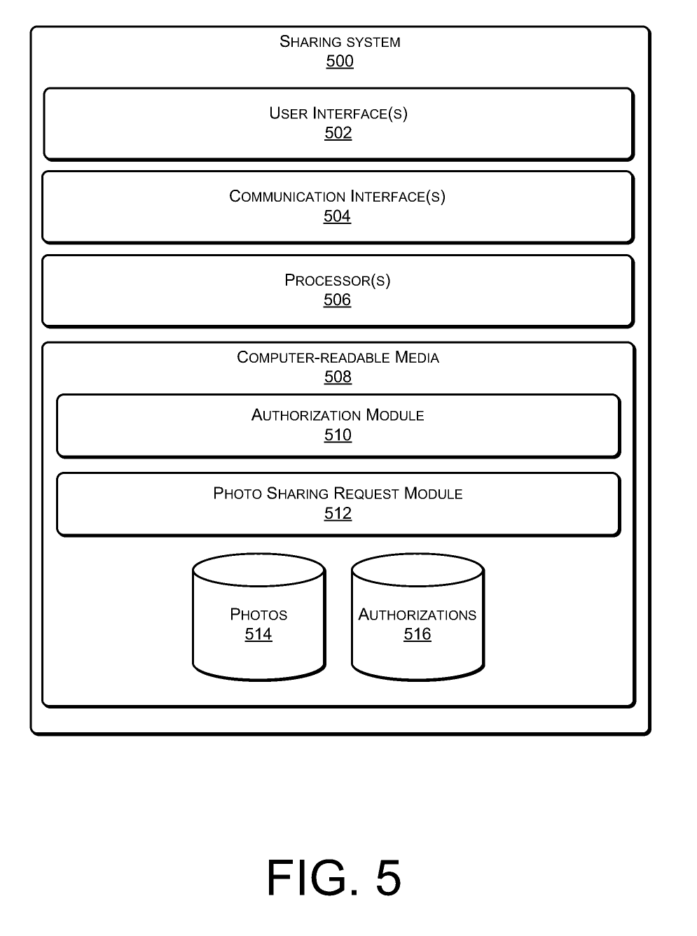

FIG. 5 illustrates an example architecture of sharing system 500 according to some implementations. The sharing system 500 may be a computing device including a user interface 502, one or more communication interfaces 504, one or more processor 506, and at least one computer-readable media 508. Examples of computing devices, which may serve as sharing system 500, include but are not limited to desktop computers, notebook computers, tablet computers, and/or smart phones. In one particular example, the sharing system 500 may be incorporated into the housing of a photo booth, such that a first user may be taking photos using the photo booth, while a second user may be viewing photos using the sharing system 500.

The user interfaces 502 may include both output interfaces for displaying or providing information to an end user and input interfaces for receiving user inputs from the end user. The user interfaces 502 may include various systems for interacting with the photo booth, such as mechanical input devices (e.g., keyboards, mice, buttons, etc.), displays, touch screens, input sensors (e.g., motion or gesture sensors), and/or microphones and speakers for capturing natural language input such as speech. In some cases, the input and output interfaces may be combined into a single interface such as a touch-enabled or touch screen display.

The one or more communication interfaces 504 are configured to facilitate communication between one or more networks, one or more cloud-based management services and/or the photo booth and the sharing system 500. The communication interfaces 504 may also facilitate communication between one or more wireless access points, a master device, and/or one or more other computing devices as part of an ad-hoc or home network system. The communication interfaces 504 may support both wired and wireless connection to various networks, such as cellular networks, radio, WiFi networks, short-range or near-field networks (e.g., Bluetooth®), infrared signals, local area networks, wide area networks, the Internet, and so forth. For example, the sharing system 500 may be in Bluetooth® communication with a photo booth while connected to the management services over a wireless router.

The one or more processors 506 may be one or more access components, control logic circuits, central processing units, or processors. Each of the processors 506 may comprise one or more processors or processing cores, such as a multi-core processor. The processors 506 are configured to access or execute instructions or modules stored on the computer-readable media 508.

The computer-readable media 508 may be an example of tangible non-transitory computer storage media and may include volatile and nonvolatile memory and/or removable and non-removable media implemented in any type of technology for storage of information such as computer-readable instructions or modules, data structures, program modules or other data. Such computer-readable media may include, but is not limited to, RAM, ROM, EEPROM, flash memory or other computer-readable media technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store information and which can be accessed by the processors 506.

Several modules such as instruction, data stores, and so forth may be stored within the computer-readable media 508 and configured to execute on the processors 506. For example, as illustrated, the computer-readable media 508 stores an authorization module 510 and a photo sharing request module 512. The computer-readable media 508 may also be configured to store data, such as photos 514 and/or authorizations 516.

The authorization module 510 may be configured to request an authorization 516 or authorization token from a sharing site that an end user desires to post a photo 514. For example, the authorization module 510 may allow the sharing system 500 to connect to a sharing site selected by an end user, such that the end user may enter login credentials at the sharing site to obtain the authorization 516 for the management services to share the photo 514 at the end user's account. The photo sharing request module 512 may be configured to provide a sharing request including an indication of a selected photo 514 and the authorization 516 to access the end user's account to the management services in response to the end user selecting a sharing site and a photo 514 to share on that site.

Generally, the sharing system 500 receives the photos 514 from the management services once the photos 514 have been edited using the promotional assets (e.g., the image assets). Once received, the sharing system 500 is configured to allow one or more end users to view the photos 514 using the user interface 502. The sharing system 500 is further configured to allow the user to select one or more photos 514 and one or more sharing sites. Once selected, the authorization module 510 obtains authorization 516 for the management services to access the end user's account at the sharing site. For example, the sharing system may allow the user to access the selected sharing sites over one or more networks, such that the user may enter login credentials to obtain the authorization 516 (e.g., an authorization token).

Once the authorization 516 is obtained, the photo sharing request module 512 sends a sharing request to the management service. The sharing request may include an indication of the photos 514 selected by the user for sharing, the selected photos 514 themselves, a list or indication of the sharing sites selected by the user, and/or the authorization 516 obtained from the sharing site by the end user. The sharing request may be utilized by the management services to post or display the selected photos 514 on the selected sharing sites.

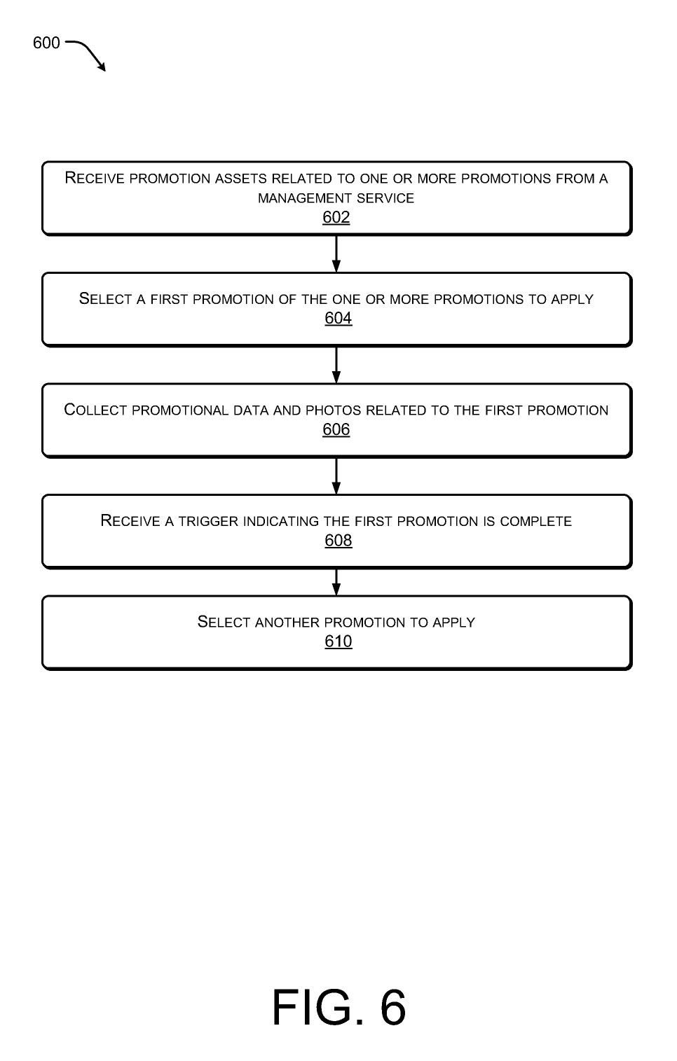

FIGS. 6-8 are flow diagrams illustrating example processes associated with a remotely updatable photo booth, according to some implementations. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 6 is an example flow diagram showing an illustrative process 600 to update a photo booth according to some implementations. At 602, a photo booth (such as photo booths 102, 202, or 300 of FIGS. 1-3) receives promotion assets related to one or more promotions from a management service (such as management services 106, 206, or 400 OF FIGS. 1, 2, and 4). For example, the photo booth may receive survey questions and corresponding answer options associated with a first promotion and a second promotion.

At 604, the photo booth selects a first promotion of the one or more promotions to apply. For example, the promotional assets may be related to a first and a second promotion of a campaign selected by the merchant The photo booth may select which of the promotions of the campaign to apply first in a variety of ways. For example, the merchant may have provided an order for the promotions as part of the promotional assets, the photo booth may be configured to select a promotion from those of a campaign at random, the photo booth may select a promotion based on a time of day or other stopping criteria, or the photo booth may select a promotion based on the durations assigned. For instance, the photo booth may select the promotion with the shortest duration as the first promotion of a campaign to apply.

At 606, the photo booth collects promotional data and photos related to the first promotion. For example, the photo booth may prompt each end user who attempts to take a photo using the photo booth to answer a survey question associated with the first promotion. The photo booth may then store the answers provided by the end users as promotional data. For instance, in some cases, the photo booth may be equipped with an internal storage media where the promotional data and photos may be stored until the promotional data and photos can be provided to the management services.

At 608, the photo booth receives a trigger indicating the first promotion is complete. For example, the trigger may be the expiration of a period of time assigned by the merchant for the promotion to run, a signal from the management services, an input at the photo booth by a technician or the merchant, and/or a signal from the merchant For example, the management services may monitor the amount of time a promotion is active on the photo booth and when the time exceeds a duration assigned to the promotion by the merchant, the management services may send a signal to the photo booth triggering the photo booth to apply another promotion.

After receiving the trigger, the photo booth determines if any additional promotions remain. For example, the photo booth may receive a trigger that indicates the first promotion of a multi-promotion campaign has expired and may determine that promotional assets related to a second promotion are stored in an internal memory and, at 610, the photo booth selects another promotion to apply. For instance, in the example above, the photo booth may select and apply the second promotion after receiving the trigger indicating that the first promotion has expired. The photo booth may then collect promotional data related to the second promotion from end users at the photo booth. If no additional promotions remain, the photo booth may be configured to apply a generic promotion and/or enter an idle state in which an advertisement or message may be displayed by the photo booth. In some instances, the photo booth when in the idle state may prevent users from capturing photos.

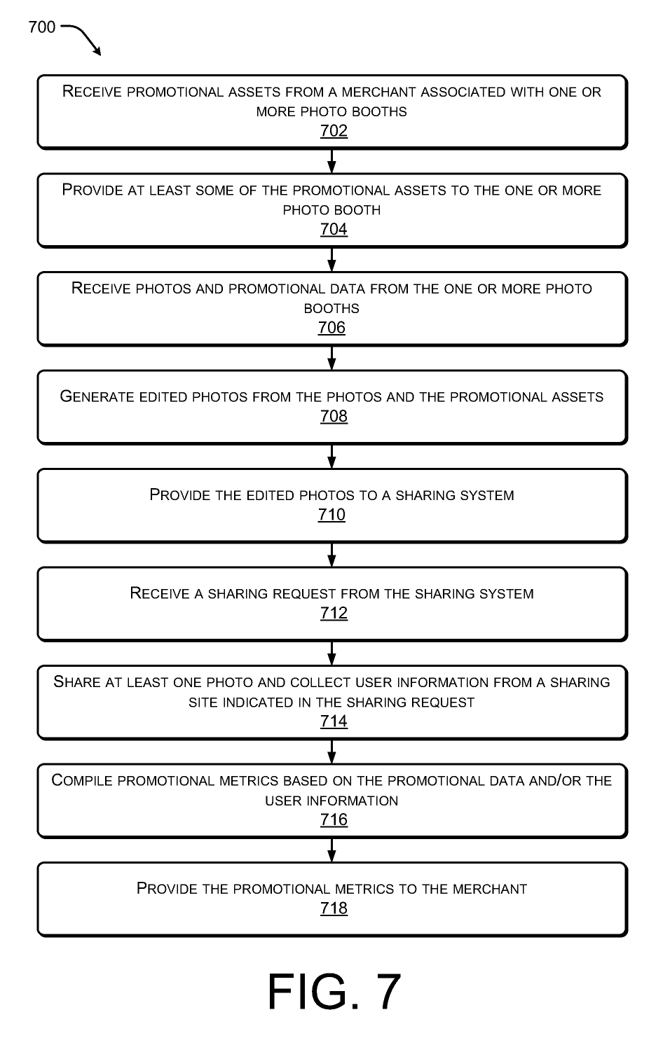

FIG. 7 is an example flow diagram showing an illustrative process 700 to generate promotional metrics for a merchant according to some implementations. At 702, management services (such as management services 106, 206, or 400 of FIGS. 1, 2, and 4) receive promotional assets from a merchant associated with one or more photo booths. For example, the merchant may access the management services using a merchant interface and upload promotional assets, such as image assets, survey questions, stopping criteria (e.g., durations), etc. related to one or more promotions of a campaign to the management services.

At 704, the management services provide at least some of the promotion assets to the one or more photo booths. For example, the management services may provide the survey questions, answer options, and/or a duration associated with the promotions selected by the merchant to the photo booths assigned to that merchant, while maintaining image assets related to the promotions at the cloud-based management services.

At 706, the management services receive photos and promotional data from the one or more photo booths assigned to the merchant For example, the management services may receive photos and answer selections for each of the end users that utilized the photo booth while the promotion was in effect.

At 708, the management services generate edited photos from the photos and the promotional assets. For example, the management services may apply a border or logo to each of the photos. In other examples, the management services may add a product associated with the merchant to each of the photos or apply a background. In some instances, the management services may apply image editing techniques such as grayscale, sepia, or antiquing to each of the photos. In some particular implementations, the management services may generate more than one edited photo from each of the photos. For example, the management services may apply a border to the photo to generate a first edited photo and apply a logo to the photo to generate a second edited photo.

At 710, the management services provide the edited photos to a sharing system and, at 712, the management services receive a sharing request from the sharing system in response. The sharing request includes a list of photos selected by an end user, a list of sharing sites selected by the end user, and authorization to access the user's account at each of the sharing sites. For example, the management services may provide photos of a particular end user to the sharing service and, in response, the user may select some of the photos for sharing on the end user's account at the sharing site and obtain authorization for the management services to share the photos on the user's account at the sharing site.

At 714, the management services share at least one photo and collect user information from a sharing site indicated in the sharing request. For example, the management services may mine or collect public data that the user has previously posted at the sharing site indicated in the sharing request. For instance, the management services may collect information related to the user's age, marital status, geographic areas where the user lives or frequently visits, gender, etc.

At 716, the management services compile promotional metrics based on the promotional data and/or the user information. For example, the metrics may include correlations, such as 95% of males between the ages of 10 and 15 selected answer A to the survey question or 15% of women prefer the orange color to the pink color. In other examples, the metrics may include statistical data such as out of 100 users 24 selected answer A, 44 answer B, 10 answer C, and 22 answer D.

At 718, the management services provide the promotional metrics to the merchant For example, the management services may send the metrics to a device registered to the merchant or provide the merchant with an access to the metrics using a merchant interface, which may provide customized views and charts for analyzing the metrics.

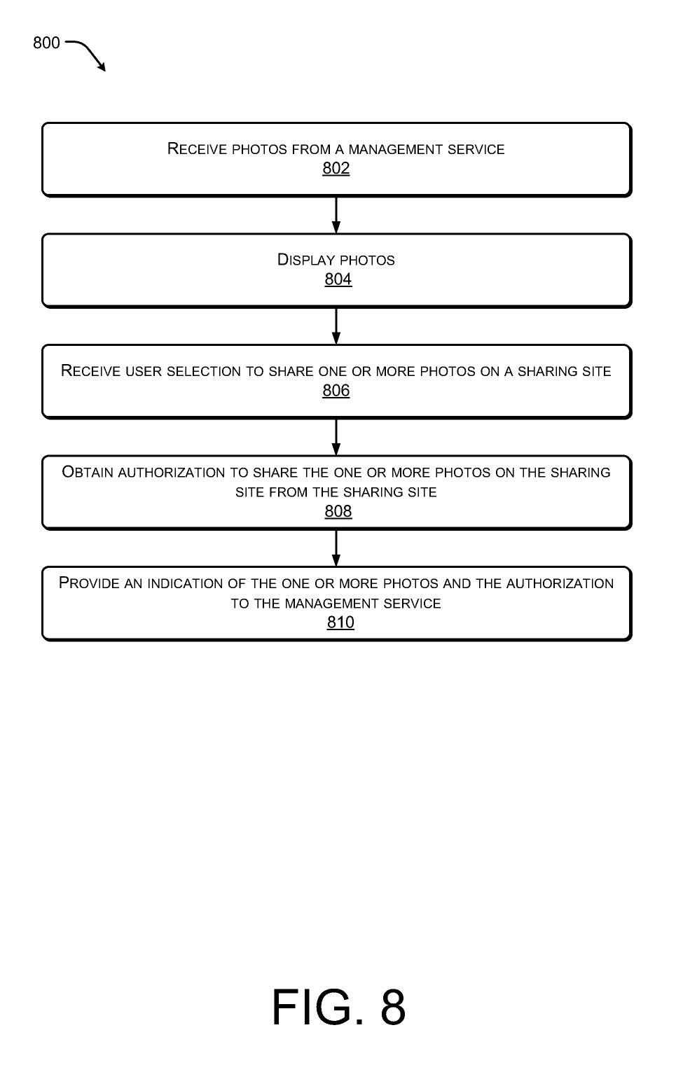

FIG. 8 is an example flow diagram showing an illustrative process 800 for sharing photos according to some implementations. At 802, a sharing system receives photos from a management service. The photos may be edited by the management service to include image assets provided by a merchant For example, the management service may have added a logo (e.g., a trademark), a border or a background selected by the merchant to the photos. In other examples, the management services may have applied one or more image editing techniques such as grayscale, sepia, or antiquing to each of the photos.

At 804, the sharing system displays the photos. For example, the sharing system may present each photo taken at a particular photo booth to every user who accesses the sharing system. In other examples, the sharing system may require a login or password before displaying photos of a particular user, for instance, to improve privacy of the photo booth system through the use of application programming interface (API).

At 806, the sharing system receives at least one user selection to share one or more photos on a sharing site. For example, the user may select one or more of the photos captured by the photo booth and edited by the management services. The user may then select one or more sharing sites on which the management service will post the photos. For instance, the user may select Instagram®, Facebook®, or an email service as the sharing sites.

At 808, the sharing system obtains authorization to share the one or more photos on the sharing site from the sharing site. For example, the sharing system may allow the user to connect with the selected sharing sites in order to obtain an authorization or authorization token for the management services to access the user's account and share the photos. In some cases, the authorization may be a onetime use token, which allows the management service to access the user's account a single time.

At 810, the sharing system provides an indication of the one or more photos and the authorization to the management service. For example, the sharing system may provide a sharing request including a list of photos (e.g., a list of serial numbers associated with the selected photos), a list of the selected sites, and/or the authorization or authorization token(s) obtained by the user from the sharing site(s) to the management services. The sharing request may cause the management services to access the user's account at the sites indicated in the list of sharing sites and to share the photos indicated in the list of photos.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A photo booth comprising:
at least one camera for capturing photos from an environment;
a first interface for displaying information and collecting promotional data from an end user utilizing the photo booth, the first interface integrated into the photo booth at a first position on a first side of the photo booth;
a second interface for displaying the photos to the end user and receiving a selection of at least one of the photos, the second interface incorporated into the photo booth at a second position on a second side of the photo booth, the second side opposite the first side;
one or more communication interfaces to communicate with one or more cloud services, the one or more cloud services including a management service;
one or more electronic processors; and
computer-readable storage media storing computer-executable instructions, which when executed by the one or more electronic processors cause the one or more electronic processors to:
receive promotional assets associated with a first promotion from the cloud services at the one or more communication interfaces;
collect, via the first interface, promotional data related to the first promotion from a first set of users, the first set of users including at least one end user of the photo booth;
capture, with the at least one camera at least one photograph of individual users of the first set of users;
display the at least one photograph via the second interface;
receive a trigger indicating the first promotion is complete;
provide the promotional data related to the first promotion and the at least one photograph of the individual users of the first set of users to the cloud services;
receive a first share request, the first share request including an indication of the at least one photograph and a first authorization token to access a first user account associated with the end user at a first sharing site;
receive a second share request, the second share request including the indication of the at least one photograph and a second authorization token to access a second user account associated with the end user at a second sharing site; and
send the at least one photograph on the user account to the first sharing site and the second sharing site.

2. The photo booth as recited in claim 1, having computer-executable instructions that, when executed by one or more electronic processors, cause the one or more processors to:
receive promotional assets associated with a second promotion from the cloud services at the one or more communication interfaces;
collect promotional data related to the second promotion from a second set of users at the user interface in response to receiving the trigger, the second set of users including at least one end user of the photo booth;
capture at least one photograph of individual users of the second set of users;
receive a second trigger indicating the second promotion is complete; and
provide the promotional data related to the second promotion and the at least one photograph of the individual users of the second set of users to the cloud services.

3. The photo booth as recited in claim 1, having computer-executable instructions that, when executed by one or more electronic processors, cause the one or more electronic processors to:
receive promotional assets associated with a plurality of promotions from the cloud services at the one or more communication interfaces;
select a second promotion from the plurality of promotions in response to receiving the trigger;
collect promotional data related to the second promotion from a second set of users at the user interface, the second set of users including at least one end user of the photo booth;
capture at least one photograph of individual users of the second set of users;
receive a second trigger indicating the second promotion is complete; and
provide the promotional data related to the second promotion and the at least one photograph of the individual users of the second set of users to the cloud services.

4. The photo booth as recited in claim 3, wherein the second promotion is selected based at least in part on:
a duration associated with each promotion of the plurality of promotions;
a preference assigned by a merchant to each of the plurality of promotions; or
an indication from the cloud services.

5. The photo booth as recited in claim 3, wherein the first set of users includes at least one user in the second set of users.

6. The photo booth as recited in claim 1, wherein the promotional data related to the first promotion and the at least one photograph of the individual users of the first set of users is provided to the cloud services after each photograph of the at least one photograph of the individual users of the first set of users is captured by the camera.

7. The photo booth as recited in claim 1, wherein the trigger is received from the cloud services.

8. The photo booth as recited in claim 1, wherein the trigger is in response to a duration associated with the first promotion expiring.

9. The photo booth as recited in claim 8, wherein the photo booth is convertible to an enclosed configuration or an open-air configuration.

10. The photo booth as recited in claim 1, wherein the promotional assets include at least one survey question and the promotional data collected at the first interface and related to the first promotion includes at least one user answer to the at least one survey question.

11. The photo booth as recited in claim 1, wherein the photo booth has an open-air design.

12. A method comprising:
receiving, with an electronic processor of a photo booth, promotional assets associated with a plurality of promotions from cloud services at a photo booth;
selecting, with the electronic processor of the photo booth, a first promotion from the plurality of promotions as an active promotion;
receiving, with the electronic processor of a photo booth, a user input from a user via a user interface of the photo booth, the user input associated with the first promotion;
capturing, with a camera of the photo booth, a first photograph of the user while the first promotion is the active promotion in response to receiving the user input;
providing, with the electronic processor of the photo booth, the user input and the first photograph to the cloud services;
receiving, at a user interface of the photo booth, authorization to access a user account associated with the user at a sharing site;
receiving a share request, the share request including an indication of the first photograph; and
directly sending the first photograph and an authorization token associated with the authorization to access the user account at the sharing site to the user account at the sharing site.

13. The method as recited in claim 12, further comprising:
receiving the promotional assets associated from cloud services at a second photo booth;
selecting, by the second photo booth, the first promotion from the plurality of promotions as an active promotion on the second photo booth;
receiving a second user input from the user associated with the first promotion via a user interface of the second photo booth;
capturing by the second photo booth a second photograph of the user while the first promotion is the active promotion on the second photo booth in response to receiving the second user input;
providing the second user input and the second photograph to the cloud services.

14. The method as recited in claim 13, wherein the first user input is in response to a first survey question associated with the first promotion and the second user input is in response to a second survey question associated with the first promotion, the first survey question different from the second survey question.

15. One or more non-transitory computer-readable media having computer-executable instructions that, when executed by one or more processors, cause the one or more electronic processors to perform operations comprising:
receiving promotional assets associated with one or more promotions from a merchant;
receiving a selection of a photo booth from a set of photo booths assigned to the merchant;
providing the promotional assets to the selected photo booth;
receiving a photograph and promotional data associated with the photograph from the photo booth;
generating a first edited photograph based at least in part on the promotional assets and the photograph;
generating a second edited photograph based at least in part on the promotional assets and the photograph, the second edited photograph different than the first edited photograph;
sending the first edited photograph and the second edited photograph to a sharing system;
receiving a share request from the sharing system, the request including an indication of a selected one of the first edited photograph or the second edited photograph and an authorization token to access a user account at the sharing site;
posting the selected one of the first edited photograph or the second edited photograph on the user account at the sharing site;
generating one or more metrics based in part on the promotional data;
making the metrics available to the merchant; and
modifying content on a web site of the merchant based on the metrics.

16. The one or more computer-readable media as recited in claim 15, having computer-executable instructions that, when executed by one or more electronic processors, cause the one or more electronic processors to perform operations comprising:
providing the edited photographs to one or more sharing systems.

17. The one or more computer-readable media as recited in claim 16, wherein the promotional assets include one or more image assets which are utilized to edit the photographs.

18. The one or more computer-readable media as recited in claim 16, having computer-executable instructions that, when executed by one or more electronic processors, cause the one or more electronic processors to perform operations comprising:
collecting user information from the user account at the sharing site; and
wherein generating the one or more metrics is based in part on the user information.

19. The one or more computer-readable media as recited in claim 15, wherein the promotional assets provided to the selected photo booth include at least one survey question and wherein the promotional data includes user answers to the survey question.

20. The one or more computer-readable media as recited in claim 15, wherein generating the first edited photograph based at least in part on information derived from the photograph.
